(19) United States
(12) Patent Application Publication
(10) Pub. No.: US 2026/0302357 A1
(43) Pub. Date: Oct. 1, 2026

(54) METHOD OF MANUFACTURING SOLID-STATE BATTERY AND SOLID-STATE BATTERY

(71) Applicant: HONDA MOTOR CO., LTD., Tokyo (JP)

(72) Inventors: Makoto IDEMOTO, Saitama (JP); Wataru SHIMIZU, Saitama (JP); Hiroshi SAKAI, Saitama (JP); Takamitsu ONUMA, Saitama (JP); Masataka FURUYAMA, Saitama (JP)

(21) Appl. No.: 19/445,639

(22) Filed: Jan. 12, 2026

(30) Foreign Application Priority Data
Mar. 31, 2025 (JP) 2025-059478

(51) Int. Cl. H01M 10/058; H01M 4/02; H01M 4/04; H01M 4/134; H01M 4/1395; H01M 4/36; H01M 4/38; H01M 4/66; H01M 10/052; H01M 10/0562

(52) U.S. Cl. CPC H01M 10/058; H01M 4/0421; H01M 4/043; H01M 4/134; H01M 4/1395; H01M 4/364; H01M 4/366; H01M 4/386; H01M 4/661; H01M 10/052; H01M 10/0562; H01M 2004/021; H01M 2004/027; H01M 2300/0068

(57) ABSTRACT

Provided is a method of manufacturing a solid-state battery, the method including: depositing a lithium film on a copper foil; applying a slurry including a silicon-based active material onto the lithium film to form a negative electrode mixture layer precursor; forming a solid electrolyte layer on the negative electrode mixture layer precursor to obtain a laminate; and applying pressure to the laminate to form a negative electrode mixture layer, in which the pressure applied to the laminate is 30 MPa or more.

This application is based on and claims the benefit of priority from Japanese Patent Application No. 2025-059478, filed on 31 Mar. 2025, the content of which is incorporated herein by reference.

### BACKGROUND OF THE SUMMARY OF THE INVENTION

### Field of the Invention

The present invention relates to a method of manufacturing a solid-state battery, and a solid-state battery.

### Related Art

In recent years, research and development has been carried out on solid-state batteries that contribute to energy efficiency in order for more people to be able to ensure access to energy that is reasonable, reliable, sustainable, and advanced.

Japanese Unexamined Patent Application, Publication No. 2014-86222 discloses a method of manufacturing a secondary battery that includes an electrolyte layer including a solid electrolyte, and a negative electrode including a negative electrode active material. At this time, pressure is applied to a laminate in a state in which a negative electrode in the laminate comprised of a current collector and the negative electrode or the laminate comprised of a current collector, a positive electrode, an electrolyte, and the negative electrode is in contact with a lithium foil attached to a copper foil so that lithium is pre-doped into the negative electrode, and then, the copper foil is peeled off.
Patent Document 1: Japanese Unexamined Patent Application, Publication No. 2014-86222

### SUMMARY OF THE INVENTION

However, in the secondary battery disclosed in Japanese Unexamined Patent Application, Publication No. 2014-86222, when a silicon-based active material is used as the negative electrode active material, initial coulombic efficiency is reduced in a case where a pre-doping rate of the negative electrode is low. It is assumed that this is because lithium is not uniformly pre-doped into the negative electrode.

It is an object for the present invention to provide a method of manufacturing a solid-state battery that uses a silicon-based active material as a negative electrode active material, and allows initial coulombic efficiency to be increased even when a pre-doping rate of a negative electrode mixture layer is low.
(1) A method of manufacturing a solid-state battery, the method including: depositing a lithium film on a copper foil; applying a slurry including a silicon-based active material onto the lithium film to form a negative electrode mixture layer precursor; forming a solid electrolyte layer on the negative electrode mixture layer precursor to obtain a laminate; and applying pressure to the laminate to form a negative electrode mixture layer, in which the pressure applied to the laminate is 30 MPa or more.
(2) The method of manufacturing a solid-state battery described in (1), in which the copper foil has a thickness of 5 μm or more and 100 μm or less.
(3) The method of manufacturing a solid-state battery described in (1) or (2), in which the lithium film has a thickness of 1 μm or more and 30 μm or less.
(4) The method of manufacturing a solid-state battery described in any one of (1) to (3), in which the negative electrode mixture layer precursor has a thickness of 10 μm or more and 200 μm or less.
(5) The method of manufacturing a solid-state battery described in any one of (1) to (4), in which the lithium film is deposited on the copper foil by a vapor deposition method.
(6) The method of manufacturing a solid-state battery described in any one of (1) to (5), in which the slurry further includes a solid electrolyte.
(7) The method of manufacturing a solid-state battery described in (6), in which the solid electrolyte is a sulfide solid electrolyte.
(8) The method of manufacturing a solid-state battery described in (7), in which the sulfide solid electrolyte is an argyrodite-type sulfide solid electrolyte.
(9) The method of manufacturing a solid-state battery described in any one of (1) to (8), in which the slurry includes a solvent.
(10) The method of manufacturing a solid-state battery described in (9), in which the solvent has a boiling point of 120° C. or higher.
(11) The method of manufacturing a solid-state battery described in any one of (1) to (10), in which the solid electrolyte layer includes a sulfide solid electrolyte.
(12) The method of manufacturing a solid-state battery described in (11), in which the sulfide solid electrolyte is an argyrodite-type sulfide solid electrolyte.
(13) A solid-state battery manufactured by a method of manufacturing a solid-state battery, the method including: depositing a lithium film on a copper foil; applying a slurry including a silicon-based active material onto the lithium film to form a negative electrode mixture layer precursor; forming a solid electrolyte layer on the negative electrode mixture layer precursor to obtain a laminate; and applying pressure to the laminate to form a negative electrode mixture layer.

According to the present invention, there can be provided a method of manufacturing a solid-state battery that uses a silicon-based active material as a negative electrode active material, and allows initial coulombic efficiency to be increased even when a pre-doping rate of a negative electrode mixture layer is low.

### BRIEF DESCRIPTION OF THE DRAWINGS

FIG. 1 is a graph showing an initial charging and discharging curve of a half-cell of Example 1; and

FIG. 2 is a graph showing an initial charging and discharging curve of a half-cell of Comparative Example 1.

### DETAILED DESCRIPTION OF THE INVENTION

Hereinafter, an embodiment of the present invention will be described.

### [Method of Manufacturing Solid-State Battery]

A method of manufacturing a solid-state battery of the present embodiment includes depositing a lithium film on a copper foil, applying a slurry including a silicon-based active material onto the lithium film to form a negative electrode mixture layer precursor, forming a solid electrolyte layer on the negative electrode mixture layer precursor to obtain a laminate, and applying pressure to the laminate to form a negative electrode mixture layer. At this time, the pressure applied to the laminate is 30 MPa or more, preferably 50 MPa or more, and more preferably 250 MPa or more. When the pressure applied to the laminate is 30 MPa or more, the initial coulombic efficiency of the solid-state battery is increased even when a pre-doping rate of the negative electrode mixture layer is low. This is because lithium is uniformly pre-doped into the negative electrode mixture layer. Note that the pressure applied to the laminate is, for example, 300 MPa or less.

At this time, the time during which the pressure is applied to the laminate may be, but is not particularly limited to, for example, 1 hour or more. The temperature when the pressure is applied to the laminate may be, but is not particularly limited to, for example, 25° C. or higher and 60° C. or lower. Furthermore, the pre-doping rate (the molar ratio of Li to Si) of the negative electrode mixture layer may be, but is not particularly limited to, for example, 0.3 or more and 1.2 or less.

Note that after the laminate is obtained, the copper foil may be peeled off, or the laminate may be used as a negative electrode collector of the solid-state battery without peeling off the copper foil.

The thickness of the copper foil is preferably 5 μm or more and 100 μm or less, and more preferably 10 μm or more and 30 μm or less. When the thickness of the copper foil is 5 μm or more, the copper foil is less likely to be warped when the pressure is applied to the laminate, making it easy for lithium to be uniformly pre-doped into the negative electrode mixture layer precursor. On the other hand, when the thickness of the copper foil is 100 μm or less, the pressure is uniformly applied to any portion of the laminate when the pressure is applied to the laminate, making it easy for lithium to be uniformly pre-doped into the negative electrode mixture layer precursor.

The thickness of the lithium film is preferably 1 μm or more and 30 μm or less, and more preferably 3 μm or more and 10 μm or less. When the thickness of the lithium film is 1 μm or more, the lithium is likely to be pre-doped into the negative electrode mixture layer precursor by a predetermined amount. On the other hand, when the thickness of the lithium film is 30 μm or less, the lithium is less likely to be excessively pre-doped into the negative electrode mixture layer precursor.

The method of depositing the lithium film on the copper foil is not particularly limited as long as a lithium film having a thickness of 1 μm or more and 30 μm or less can be deposited, but an example of the method is a vapor deposition method.

The thickness of the negative electrode mixture layer precursor is preferably 10 μm or more and 200 μm or less, and more preferably 10 μm or more and 50 μm or less. When the thickness of the negative electrode mixture layer precursor is 10 μm or more, the lithium is likely to be pre-doped into the negative electrode mixture layer precursor by a predetermined amount, and the initial coulombic efficiency is likely to be increased. On the other hand, when the thickness of the negative electrode mixture layer precursor is 200 μm or less, the lithium is likely to be uniformly pre-doped into the negative electrode mixture layer precursor at any portion of the laminate, and the initial coulombic efficiency is likely to be increased.

The thickness of the negative electrode mixture layer precursor may be, but is not particularly limited to, for example, 10 μm or more and 50 μm or less.

The content of silicon in the silicon-based active material in solids contained in the slurry is preferably 50% by mass or more and 80% by mass or less, and more preferably 50% by mass or more and 70% by mass or less. When the content of silicon in the silicon-based active material in solids contained in the slurry is 50% by mass or more and 80% by mass or less, the lithium is likely to be pre-doped into the negative electrode mixture layer precursor.

Note that the silicon-based active material is preferably a composite material (silicon-based composite material) of silicon and an element other than silicon. The silicon-based composite material is not particularly limited as long as the silicon-based composite material can absorb and release lithium ions, and examples of the silicon-based composite material include a silicon/carbon composite material, a silicon/nitrogen composite material, a silicon/titanium composite material, a silicon/aluminum composite material, a silicon/lithium composite material, and a silicon/copper composite material.

The slurry preferably further includes a solid electrolyte. This makes it easy for lithium to be pre-doped into the negative electrode mixture layer precursor, and makes it possible to increase the initial coulombic efficiency of the solid-state battery.

The solid electrolyte is not particularly limited as long as the solid electrolyte can conduct lithium ions, and examples of the solid electrolyte include an oxide solid electrolyte and a sulfide solid electrolyte. Among them, the sulfide solid electrolyte is preferable that makes it easy for lithium to be pre-doped into the negative electrode mixture layer precursor and makes it possible to increase the initial coulombic efficiency of the solid-state battery, and an argyrodite-type sulfide solid electrolyte is particularly preferable.

The sulfide solid electrolyte included in the solid electrolyte layer contains, for example, a metal element (M) serving as a conducting ion, and sulfur(S). Examples of the metal element M include Li, Na, K, Mg, and Ca. Among them, Li is preferable.

The sulfide solid electrolyte preferably contains Li, A which is at least one element selected from the group consisting of P, Si, Ge, Al, and B, and S, and more preferably contains Li and P. Note that the sulfide solid electrolyte may further contain a halogen element (for example, Cl, Br, or I) from the viewpoint of ion conductivity. The sulfide solid electrolyte may further contain 0.

Examples of the sulfide solid electrolyte include Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—PS₅—ZₘSₙ (where m and n are positive numbers, and Z is Ge, Zn, or Ga), Li₂S—GeS₂, Li₂S—SiS₂—Li₃PO₄, Li₂S—SiS₂—LiₓMO_{y} (where x and y are positive numbers, and M is P, Si, Ge, B, Al, Ga or In), and LiᵥP_{w}SₓCl_{y}Br_{z} (v, w, x, y, z>0). Among them, from the viewpoint of ion conductivity, LiᵥP_{w}SₓCl_{y}Br_{z} (v, w, x, y, z>0) is preferable, and LiᵥP_{w}SₓCl_{y}Br_{z} (0<v<10, 0<w<5, 0<x<5, 0<y<5, 0<z<5) is more preferable, and examples of LiᵥP_{w}SₓCl_{y}Br_{z} include Li_{5.4}PS_{4.4}Cl_{0.8}Br_{0.8}.

For example, the above description of “Li₂S—P₂S₅” means a sulfide solid electrolyte produced using a raw material composition containing Li₂S and P₂S₅, and the same applies to the other descriptions.

The sulfide solid electrolyte may be a sulfide glass or a crystallized sulfide glass, and may be a crystalline material obtained by a solid-phase method. Note that the sulfide glass is obtained, for example, by performing a mechanical milling method (for example, a milling method using a ball mill) on a raw material composition. The crystallized sulfide glass can be obtained, for example, by performing heat treatment on the sulfide glass at a temperature equal to or higher than a crystallization temperature.

The sulfide solid electrolyte included in the solid electrolyte layer is preferably an argyrodite-type sulfide solid electrolyte. Since the lithium is likely to be pre-doped into the negative electrode mixture layer precursor, and the initial coulombic efficiency of the solid-state battery is increased, the sulfide solid electrolyte is preferable, and the argyrodite-type sulfide solid electrolyte is particularly preferable.

A median size of the solid electrolyte is preferably 100 nm or more and 1000 nm or less, and more preferably 100 nm or more and 700 nm or less. When the median size of the solid electrolyte is 100 nm or more, the aggregation of the solid electrolyte is reduced, and when the median size of the solid electrolyte is 1000 nm or less, the aggregation of the silicon-based active material is reduced.

The content of the solid electrolyte in solids contained in the slurry is preferably 10% by mass or more and 50% by mass or less, and more preferably 20% by mass or more and 50% by mass or less. When the content of the solid electrolyte in solids contained in the slurry is 10% by mass or more and 50% by mass or less, the lithium is likely to be pre-doped into the negative electrode mixture layer precursor.

The slurry may further include a binder. Examples of the binder include, but are not particularly limited to, a fluororesin binder such as polyvinylidene fluoride (PVDF), polytetrafluoroethylene (PTFE), a polyvinylidene fluoride-polyhexafluoropropylene copolymer (PVDF-HFP), and fluororubber, and a non-fluororubber binder such as a butadiene rubber, a hydrogenated butadiene rubber, a styrene butadiene rubber (SBR), a hydrogenated styrene butadiene rubber, a nitrile butadiene rubber, a hydrogenated nitrile butadiene rubber, and an ethylene propylene rubber. As the binder, an acryl-based binder, or a polyimide-based binder may be used. The content of the binder in solids contained in the slurry may be, but is not particularly limited to, for example, 0.5% by mass or more and 3% by mass or less.

The slurry may further include a conductive aid. Examples of the conductive aid include, but are not particularly limited to, acetylene black, metallic carbon nanotubes (MCNTs), and semiconductor carbon nanotubes (SCNTs). The content of the conductive aid in solids contained in the slurry may be, but is not particularly limited to, for example, 0.05% by mass or more and 5% by mass or less.

The slurry preferably further includes a solvent. This makes it easy for lithium to be uniformly pre-doped into the negative electrode mixture layer precursor.

The boiling point of the solvent may be 120° C. or higher or 140° C. or higher. When the boiling point of the solvent is 120° C. or higher, the negative electrode mixture layer precursor having a predetermined thickness can be easily obtained, and the initial coulombic efficiency of the solid-state battery is likely to be increased. Note that the boiling point of the solvent is, for example, 200° C. or lower.

Examples of the solvent having a boiling point of 120° C. or higher include, but are not particularly limited to, butyl butyrate (boiling point 166° C.), o-xylene (boiling point 144° C.), m-xylene (boiling point 139° C.), p-xylene (boiling point 138° C.), and decane (boiling point 174° C.). Among them, the butyl butyrate is preferable that makes it easy for lithium to be uniformly pre-doped into the negative electrode mixture layer precursor.

Examples of the solid electrolyte included in the solid electrolyte layer include, but are not particularly limited to, a sulfide solid electrolyte and an oxide solid electrolyte. Among them, from the viewpoint of initial coulombic efficiency of the solid-state battery, the sulfide solid electrolyte is preferable, and the argyrodite-type sulfide solid electrolyte is particularly preferable.

Examples of the form of the solid electrolyte include, but are not particularly limited to, particles.

The content of the solid electrolyte in the solid electrolyte layer may be, but is not particularly limited to, for example, 50% by mass or more and 99% by mass or less.

The solid electrolyte layer may further include a binder, and the like.

The thickness of the solid electrolyte layer may be, but is not particularly limited to, for example, 10 μm or more and 600 μm or less.

Examples of a method of forming the solid electrolyte layer include, but are not particularly limited to, a method of press-forming a composition including the solid electrolyte.

The laminate is not particularly limited as long as the laminate is one in which the copper foil, the lithium film, the negative electrode mixture layer precursor, and the solid electrolyte layer are sequentially laminated, and examples of the laminate include a laminate comprised of a copper foil, a lithium film, a negative electrode mixture layer precursor, and a solid electrolyte layer, a laminate comprised of a copper foil, a lithium film, a negative electrode mixture layer precursor, a solid electrolyte layer, and a positive electrode mixture layer, and a laminate comprised of a copper foil, a lithium film, a negative electrode mixture layer precursor, a solid electrolyte layer, a positive electrode mixture layer, and a positive electrode current collector.

Examples of the solid-state battery include, but are not particularly limited to, an all-solid-state lithium ion secondary battery and a semi-solid-state lithium ion secondary battery.

Hereinafter, there will be described an example of a method of manufacturing an all-solid-state lithium ion secondary battery in which a laminate comprised of a copper foil, a lithium film, a negative electrode mixture layer precursor, and a solid electrolyte layer is used as the laminate.

The pressure is applied to the laminate comprised of the copper foil, the lithium film, the negative electrode mixture layer precursor, and the solid electrolyte layer to form the negative electrode mixture layer into which lithium is pre-doped, obtaining a laminate comprised of the copper foil, the negative electrode mixture layer, and the solid electrolyte layer. Next, the copper foil is peeled off from the laminate comprised of the copper foil, the negative electrode mixture layer, and the solid electrolyte layer, obtaining a laminate comprised of the negative electrode mixture layer and the solid electrolyte layer. Next, a positive electrode mixture layer and a positive electrode current collector are sequentially laminated on a surface on the side on which the solid electrolyte layer is formed in the laminate comprised of the negative electrode mixture layer and the solid electrolyte layer, obtaining a laminate comprised of the negative electrode mixture layer, the solid electrolyte layer, the positive electrode mixture layer, and the positive electrode current collector. In addition, a negative electrode current collector is formed on a surface on the side on which the negative electrode mixture layer is formed in the laminate comprised of the negative electrode mixture layer, the solid electrolyte layer, the positive electrode mixture layer, and the positive electrode current collector, obtaining an all-solid-state lithium ion secondary battery.

Note that the order of forming each layer on the laminate comprised of the negative electrode mixture layer and the solid electrolyte layer is not limited to a particular order. The all-solid-state lithium ion secondary battery may be subjected to formation as necessary, to obtain the all-solid-state lithium ion secondary battery.

Examples of the material constituting the negative electrode current collector include, but are not particularly limited to, silver, palladium, gold, platinum, aluminum, copper, nickel, stainless steel, and carbon. Among them, copper, stainless steel, and nickel are preferable from the viewpoint of conductivity and cost.

Examples of the shape of the negative electrode current collector include, but are not particularly limited to, a foil shape, a plate shape, a mesh shape, a nonwoven fabric shape, and a foam shape.

The positive electrode mixture layer includes a positive electrode active material. Examples of the positive electrode active material include, but are not particularly limited to, a lithium cobaltate (LiCoO₂), lithium nickelate (LiNiO₂), LiNiₚMn_{q}CoᵣO₂ (p+q+r=1), LiNiₚAl_{q}CoᵣO₂ (p+q+r=1), lithium manganate (LiMn₂O₄), Li₁₊ₓMn_{2-x-y}M_{y}O₄ (x+y=2) (where M is at least one element selected from the group consisting of Al, Mg, Co, Fe, Ni, and Zn), lithium titanate, LiMPO₄ (where M is at least one element selected from the group consisting of Fe, Mn, Co, and Ni).

The content of the positive electrode active material in the positive electrode mixture layer may be, but is not particularly limited to, for example, 50% by mass or more and 99% by mass or less.

The positive electrode mixture layer may further include a solid electrolyte. The solid electrolyte is not particularly limited as long as the solid electrolyte can conduct lithium ions, and examples of the solid electrolyte include an oxide solid electrolyte and a sulfide solid electrolyte.

The positive electrode mixture layer may further include a binder, a conductive aid, and the like.

Examples of a method of forming the positive electrode mixture layer include, but are not particularly limited to, a method of applying a slurry including a positive electrode active material and a solvent.

Examples of the material constituting the positive electrode current collector include, but are not particularly limited to aluminum, an aluminum alloy, stainless steel, nickel, iron, and titanium. Among them, aluminum, an aluminum alloy, and stainless steel are preferable.

Examples of the shape of the positive electrode current collector include, but are not particularly limited to, a foil shape and a plate shape.

Although embodiments of the present invention have been described above, the present invention is not limited to the above-described embodiments, and the above-described embodiments may be appropriately modified within the scope of the gist of the present invention.

### EXAMPLES

Although Examples of the present invention will be described, the present invention is not limited to Examples below.

### Example 1

### (Vapor Deposition)

A lithium film having a thickness of 6.5 μm was deposited on a copper foil having a thickness of 10 μm using a vacuum vapor deposition apparatus, obtaining a pre-doping substrate.

As described below, a slurry, a laminate comprised of a copper foil, a lithium film, and a negative electrode mixture layer precursor, a solid electrolyte layer, and a half cell were manufactured in a glove box in which the atmosphere was replaced with argon.

### (Manufacture of Slurry)

A rotating and revolving mixer was used to mix 70 parts by mass of a silicon/carbon composite material and 29 parts by mass of an argyrodite-type sulfide solid electrolyte (Li_{5.4}PS_{4.4}Cl_{0.8}Br_{0.8}) having a median size (D₅₀) of 700 nm. Next, 1 part by mass of polyvinylidene fluoride (PVDF) and butyl butyrate were added to and mixed with the mixture using the rotating and revolving mixer, and then, the resulting mixture was dispersed using an ultrasonic homogenizer, obtaining a slurry. Here, butyl butyrate had a boiling point of 166° C.

### (Manufacture of Laminate Comprised of Copper Foil, Lithium Film, and Negative Electrode Mixture Layer Precursor)

The slurry was applied on a lithium film which was a pre-doping substrate using an applicator, and dried to form a negative electrode mixture layer precursor having a thickness of 20 μm, and then the formed negative electrode mixture layer precursor was punched, obtaining a laminate comprised of a copper foil, the lithium film, and the negative electrode mixture layer precursor. At this time, the drying was performed at 40° C. for 30 minutes, and then was performed at 60° C. for 30 minutes.

### (Manufacture of Solid Electrolyte Layer)

The argyrodite-type sulfide solid electrolyte (Li_{5.4}PS_{4.4}Cl_{0.8}Br_{0.8}) having a median size (D₅₀) of 700 nm was press-formed at a pressure of 145 MPa, obtaining a solid electrolyte layer.

### (Manufacture of Half Cell)

The pressure was applied, for 3 days under the conditions of the temperature of 25° C. and the pressure of 60 MPa, to the laminate comprised of the copper foil, the lithium film, and the negative electrode mixture layer precursor in a state in which the solid electrolyte layer, an indium foil, and a lithium foil were sequentially arranged on the negative electrode mixture layer precursor in the laminate, to form a negative electrode mixture layer into which lithium having a thickness of 25 μm was pre-doped, and then the copper foil was peeled off from the laminate, obtaining a half cell. At this time, the lithium film was not present on a surface of the negative electrode mixture layer, and the pre-doping rate (a molar ratio of Li to Si) of the negative electrode mixture layer was 0.56.

### Comparative Example 1

As described below, a laminate comprised of a copper foil and a negative electrode mixture layer, a solid electrolyte layer, and a half cell were manufactured in a glove box in which the atmosphere was replaced with argon.

### (Manufacture of Laminate Comprised of Copper Foil and Negative Electrode Mixture Layer)

The slurry was applied on a copper foil having a thickness of 10 μm which served as a negative electrode current collector using an applicator, and dried similarly to Example 1, to form a negative electrode mixture layer having a thickness of 20 μm, and then the formed negative electrode mixture layer was punched, obtaining a laminate comprised of the copper foil and the negative electrode mixture layer.

### (Manufacture of Solid Electrolyte Layer)

The argyrodite-type sulfide solid electrolyte (Li_{5.4}PS_{4.4}Cl_{0.8}Br_{0.8}) having a median size (D₅₀) of 700 nm was press-formed at a pressure of 145 MPa, obtaining a solid electrolyte layer.

### (Manufacture of Half Cell)

The pressure was applied, for 3 days under the conditions of the temperature of 25° C. and the pressure of 60 MPa, to the laminate comprised of the copper foil and the negative electrode mixture layer in a state in which the solid electrolyte layer, an indium foil, and a lithium foil were sequentially arranged on the negative electrode mixture layer in the laminate, obtaining a half cell.

### [Initial Coulombic Efficiency]

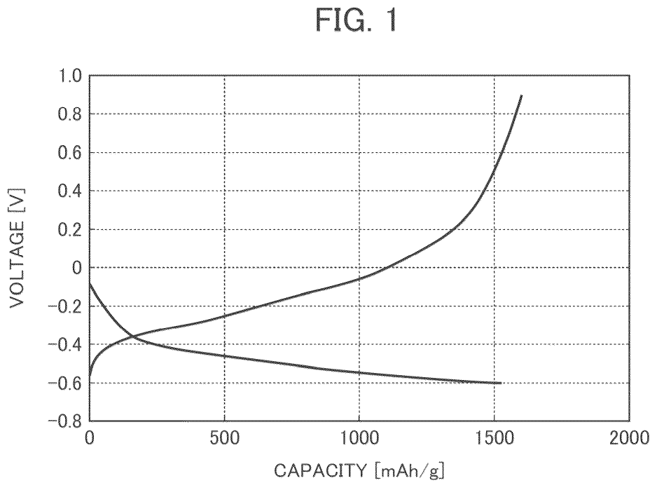

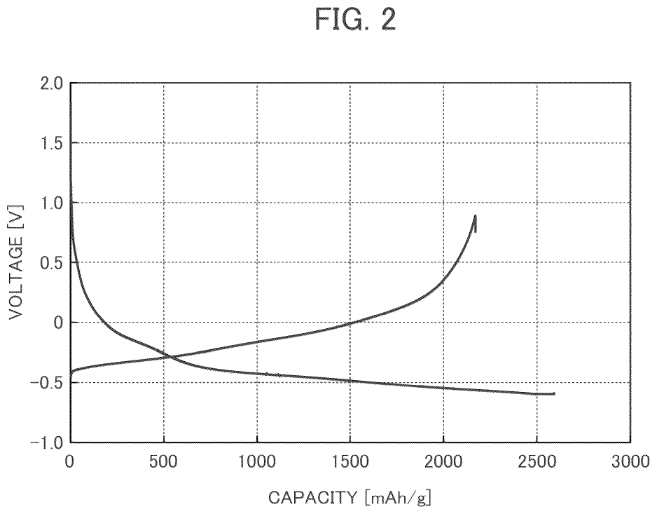

A charging and discharging test was performed on the half cell in each of Example 1 and Comparative Example 1. Specifically, a half cell of a laminate comprised of the negative electrode mixture layer, the indium foil, and the lithium foil was produced, and the initial coulombic efficiency (a ratio of an initial discharging capacity to an initial charging capacity). FIGS. 1 and 2 show respective initial charging and discharging curves of the half cells of Example 1 and Comparative Example 1.

It can be seen that the steep inclination portion of the capacities in the vicinity of 0 mAh/g in the initial discharging curve of FIG. 2 is not present in the capacities in the vicinity of 0 mAh/g in the initial discharging curve of FIG. 1. This is because the lithium is pre-doped into the negative electrode mixture layer of the half cell of Example 1.

Table 1 shows evaluation results of the initial coulombic efficiency of each half cell.

TABLE 1

| | | Pre-doping | |
|---|---|---|---|
| | Pre-doping | rate | Initial coulombic |
| | substrate | (—) | efficiency[%] |
| Example 1 | Used | 0.68 | 105.0 |
| Comparative | Unused | 0 | 83.8 |
| Example 1 | | | |

It can be seen from Table 1 that in the half cell of Example 1, the initial coulombic efficiency is high even when the pre-doping rate is low. In contrast, in the half cell of Comparative Example 1, since the lithium is not pre-doped into the negative electrode mixture layer, the initial coulombic efficiency is low.

### (Cross-Sectional SEM Image)

The cross sections at three points in the half cell of each of Example 1 and Comparative Example 1 were observed using a scanning electron microscope (SEM) (at a magnification of 1000 times)

As a result, it was confirmed that an average value (17 μm) of thicknesses at the three points in the negative electrode mixture layer of Example 1 was larger than an average value (10 μm) of thicknesses at the three points in the negative electrode mixture layer of Comparative Example 1. This is because the lithium is pre-doped into the negative electrode mixture layer of Example 1.

The composition of the negative electrode mixture layer in the cross-sectional SEM image of the half cell of each of Example 1 and Comparative Example 1 was analyzed using an energy-dispersive X-ray fluorescence spectrometer (EDX) attached to the SEM. Specifically, the contents of the elements (Si, F, P, S, Cl, and Br) in each of an upper portion, a center portion, and a lower portion obtained by dividing the negative electrode mixture layer into three having an equal area in the thickness direction at each of the three cross sections were analyzed. Next, an average value and standard deviation of the contents of each element in nine regions were obtained, and then the standard deviation was divided by the average value, calculating a variation coefficient.

Tables 2 and 3 show analysis results of the negative electrode mixture layer compositions in the cross-sectional SEM images of the half cells of Example 1 and Comparative Example 1, respectively.

TABLE 2

| | | Si | F | P | S | Cl | Br |
|---|---|---|---|---|---|---|---|
| Measurement | Upper portion | 25.83 | 2.15 | 1.98 | 9.3 | 1.58 | 1.65 |
| point1 | Center portion | 26.78 | 2.12 | 1.98 | 9.48 | 1.88 | 1.87 |
| | Lower portion | 26.15 | 2.21 | 2.02 | 10.12 | 1.71 | 1.81 |
| Measurement | Upper portion | 24.93 | 1.88 | 1.73 | 9.34 | 1.55 | 1.73 |
| point2 | Center portion | 24.99 | 2.08 | 2.02 | 9.45 | 1.68 | 1.8 |
| | Lower portion | 26.33 | 2.13 | 2.07 | 9.73 | 1.69 | 1.74 |
| Measurement | Upper portion | 26.37 | 1.87 | 1.92 | 9.45 | 1.82 | 1.75 |
| point3 | Center portion | 25.07 | 2.14 | 2 | 9.7 | 1.71 | 1.85 |
| | Lower portion | 26.22 | 2.04 | 1.85 | 10.06 | 1.75 | 1.72 |

| | | | | | | |
|---|---|---|---|---|---|---|
| Average value | 25.63 | 2.07 | 1.95 | 9.63 | 1.71 | 1.77 |
| Variation coefficient | 2.16% | 5.44% | 5.06% | 2.94% | 5.74% | 3.71% |

TABLE 3

| | | Si | F | P | S | Cl | Br |
|---|---|---|---|---|---|---|---|
| Measurement | Upper portion | 30.03 | 2.27 | 1.98 | 8.51 | 1.69 | 1.79 |
| point1 | Center portion | 29.45 | 2.43 | 2.14 | 9.47 | 1.66 | 2.09 |
| | Lower portion | 32.15 | 2.01 | 1.97 | 8.26 | 1.67 | 1.72 |
| Measurement | Upper portion | 31.36 | 2.62 | 2.2 | 9.26 | 1.61 | 2.02 |
| point2 | Center portion | 30.7 | 2.29 | 2.27 | 9.8 | 1.76 | 2.01 |
| | Lower portion | 31.41 | 2.16 | 2.05 | 8.84 | 1.77 | 1.78 |
| Measurement | Upper portion | 30.92 | 2.41 | 2.21 | 9.78 | 1.96 | 2.17 |
| point3 | Center portion | 31.53 | 2.36 | 2.08 | 9.08 | 1.96 | 1.85 |
| | Lower portion | 31.64 | 1.85 | 1.69 | 8.17 | 1.78 | 1.66 |

| | | | | | | |
|---|---|---|---|---|---|---|
| Average value | 31.02 | 2.27 | 2.07 | 9.02 | 1.76 | 1.90 |
| Variation coefficient | 2.58% | 9.67% | 7.98% | 6.45% | 6.71% | 8.86% |

It can be seen from Tables 2 and 3 that all of Si, F, P, S, Cl, and Br in the negative electrode mixture layer of Example 1 have smaller variation coefficients than those in the negative electrode mixture layer of Comparative Example 1, and the silicon/carbon composite material, PVDF, and Li_{5.4}PS_{4.4}Cl_{0.8}Br_{0.8} are uniformly present at any measurement point in the negative electrode mixture layer. Hese, it is considered that Si is derived from the silicon/carbon composite material, F is derived from PVDF, P, S, Cl, and Br are derived from Li_{5.4}PS_{4.4}Cl_{0.8}Br_{0.8}. Therefore, it can be seen that the lithium is uniformly pre-doped into the negative electrode mixture layer of Example 1.

What is claimed is:

1. A method of manufacturing a solid-state battery, the method comprising:
depositing a lithium film on a copper foil;
applying a slurry including a silicon-based active material onto the lithium film to form a negative electrode mixture layer precursor;
forming a solid electrolyte layer on the negative electrode mixture layer precursor to obtain a laminate; and
applying pressure to the laminate to form a negative electrode mixture layer,
wherein the pressure applied to the laminate is 30 MPa or more.

2. The method of manufacturing a solid-state battery according to claim 1, wherein
the copper foil has a thickness of 5 μm or more and 100 μm or less.

3. The method of manufacturing a solid-state battery according to claim 1, wherein
the lithium film has a thickness of 1 μm or more and 30 μm or less.

4. The method of manufacturing a solid-state battery according to claim 1, wherein
the negative electrode mixture layer precursor has a thickness of 10 μm or more and 200 μm or less.

5. The method of manufacturing a solid-state battery according to claim 1, wherein
the lithium film is deposited on the copper foil by a vapor deposition method.

6. The method of manufacturing a solid-state battery according to claim 1, wherein
the slurry further includes a solid electrolyte.

7. The method of manufacturing a solid-state battery according to claim 6, wherein
the solid electrolyte is a sulfide solid electrolyte.

8. The method of manufacturing a solid-state battery according to claim 7, wherein
the sulfide solid electrolyte is an argyrodite-type sulfide solid electrolyte.

9. The method of manufacturing a solid-state battery according to claim 1, wherein
the slurry includes a solvent.

10. The method of manufacturing a solid-state battery according to claim 9, wherein
the solvent has a boiling point of 120° C. or higher.

11. The method of manufacturing a solid-state battery according to claim 1, wherein
the solid electrolyte layer includes a sulfide solid electrolyte.

12. The method of manufacturing a solid-state battery according to claim 11, wherein
the sulfide solid electrolyte is an argyrodite-type sulfide solid electrolyte.

13. A solid-state battery manufactured by a method of manufacturing a solid-state battery, the method comprising:
depositing a lithium film on a copper foil;
applying a slurry including a silicon-based active material onto the lithium film to form a negative electrode mixture layer precursor;
forming a solid electrolyte layer on the negative electrode mixture layer precursor to obtain a laminate; and
applying pressure to the laminate to form a negative electrode mixture layer.
